(19) United States
(12) Patent Application Publication
(10) Pub. No.: US 2006/0145001 A1
(43) Pub. Date: Jul. 6, 2006

(54) Fan cowl door elimination

(76) Inventor: Matthew C. Smith, Seattle, WA (US)

Correspondence Address: HARNESS, DICKEY & PIERCE, P.L.C., P.O. BOX 828, BLOOMFIELD HILLS, MI, 48303, US

(21) Appl. No.: 11/026,888

(22) Filed: Dec. 30, 2004

(51) Int. Cl. F02K 1/54

(52) U.S. Cl. 244/110 B

(57) ABSTRACT

A nacelle for housing an aircraft jet engine. The jet engine has a fan case and a portion disposed downstream of the fan case relative to a direction of airflow through the jet engine. The nacelle comprises an inlet for receiving airflow, a fan cowl panel for covering a forward portion of the fan case, and a thrust reverser having a longitudinal length sufficient to cover the downstream portion of the jet engine in addition to a rearward portion of the fan case. Opening the thrust reverser enables access to an entire area formed by the downstream portion as well as the rearward portion of the fan case.

### FIELD OF THE INVENTION

The present invention relates to aircraft engine nacelles. In particular, the present invention relates to an aircraft engine nacelle having a thrust reverser that overlaps a portion of an aircraft engine fan case.

### BACKGROUND OF THE INVENTION

With reference to FIG. 1, a conventional aircraft engine nacelle is illustrated at 10. The nacelle 10 houses a conventional aircraft engine 12. The nacelle 10 generally includes an inlet cowl 14, a fan cowl panel 16, and a thrust reverser 18. The engine 12 generally includes a fan case 20 and various components aft of the fan case, such as an engine core 22 including a nozzle 24. The inlet cowl 14 surrounds an area forward of the fan case 20. The fan cowl 16 surrounds and covers the fan case 20. The thrust reverser 18 surrounds and covers the engine core 22. The thrust reverser 18 does not cover the fan case 20.

Mounted to the fan case 20 are various components and devices of the engine 12, such as an oil tank 26, an engine control unit (ECU) 27, and often a gear box 28. To gain access to the fan case 20 and the components mounted to the fan case 20, such as the oil tank 26, ECU 27, and the gear box 28, the fan cowl panel 16 is opened. To gain access to the components of the engine core 22, both the fan cowl panel 16 and the thrust reverser 18 are opened. Both the fan cowl 16 and the thrust reverser 18 open in a “clam-like” fashion using a sophisticated hydraulic lift system. Both the fan cowl 16 and the thrust reverser 18 cover important components of the engine 12 and need to be opened to permit access to these components. The fan cowl panel 16 and the thrust reverser 18 each include a separate hydraulic lift system (not shown) that opens the panel 16 and the thrust reverser 18 and supports them in the open position. These lift systems add to the overall weight of the aircraft.

While conventional aircraft engine nacelles are suitable for their intended uses, they are subject to improvement. In particular, there is a need for an aircraft engine nacelle having a reduced weight and reduced complexity, as compared to conventional nacelles, but which still provides easy access to those areas normally covered by the thrust reverser and the fan cowl panel.

### SUMMARY OF THE INVENTION

The present invention provides for a nacelle for housing an aircraft jet engine. The jet engine has a fan case and a portion disposed downstream of the fan case relative to a direction of airflow through the jet engine. The nacelle comprises an inlet for receiving airflow, a fan cowl panel for covering a forward portion of the fan case, and a thrust reverser having a longitudinal length sufficient to cover the downstream portion of the jet engine in addition to a rearward portion of the fan case. Opening the thrust reverser enables access to an entire area formed by the downstream portion as well as the rearward portion of the fan case. Because the thrust reverser overlaps the fan case, opening the thrust reverser permits access to the fan case and engine components associated with the fan case. There is seldom a need to open the fan cowl panel to access the forward fan case and the conventional fan cowl can be eliminated in some embodiments. Therefore, the conventional mechanism used to automatically open and close the fan cowl can be eliminated and some structural weight elements reduced to reduce the weight of the nacelle and realize enhanced fuel efficiency.

The present invention further provides for a nacelle for housing an aircraft jet engine. The jet engine has a fan case and a portion disposed downstream of the fan case relative to a direction of air flowing through the jet engine. The nacelle comprises an inlet for receiving airflow, a fan cowl panel for covering about a forward half of the fan case, and a thrust reverser. The thrust reverser includes a main body having a longitudinal length sufficient to cover the downstream portion of the jet engine and an extended portion mounted to the main body having a longitudinal length sufficient to cover approximately an aft half of the fan case. Opening the thrust reverser enables access to an entire area formed by the downstream portion as well as approximately the aft half of the fan case.

The present invention still further provides for a nacelle for housing an aircraft jet engine. The jet engine has a fan case and a portion disposed downstream of the fan case relative to a direction of air flowing through the jet engine. The nacelle includes an inlet for receiving airflow and a thrust reverser having a longitudinal length sufficient to cover the downstream portion of the jet engine and the entire fan case. Opening the thrust reverser enables access to an entire area formed by the downstream portion as well as the entire fan case.

The features, functions, and advantages can be achieved independently in various embodiments of the present inventions or may be combined in yet other embodiments.

### BRIEF DESCRIPTION OF THE DRAWINGS

The present invention will become more fully understood from the detailed description and the accompanying drawings, wherein:

FIG. 1 is a side view of a prior art aircraft engine nacelle;

FIG. 2 is a side view of an aircraft engine nacelle according to an embodiment of the present invention;

FIG. 3 is a top view of the nacelle of FIG. 2;

FIG. 4 is a bottom view of the nacelle of FIG. 2;

FIG. 5 is a cross-sectional view along line 5-5 of FIG. 2;

FIG. 5A is a close-up view of area 5A of FIG. 5;

FIG. 5B is a close-up view of area 5B of FIG. 5;

FIG. 5C is a close-up view of area 5C of FIG. 5;

FIG. 5D is a close-up view of area 5D of FIG. 5;

FIG. 6A is a perspective view of the nacelle of FIG. 2;

FIG. 6B is a close-up view of the nacelle of FIG. 6A;

FIG. 7 is a perspective view of the nacelle of FIG. 2;

FIG. 8 is a perspective view of the nacelle of FIG. 2;

FIG. 9 is a cross-sectional view taken along line 9-9 of FIG. 8;

FIG. 10 is a side view of an aircraft engine nacelle according to another embodiment of the present invention; and

FIG. 11 is a cross-sectional view taken along line 11-11 of FIG. 10.

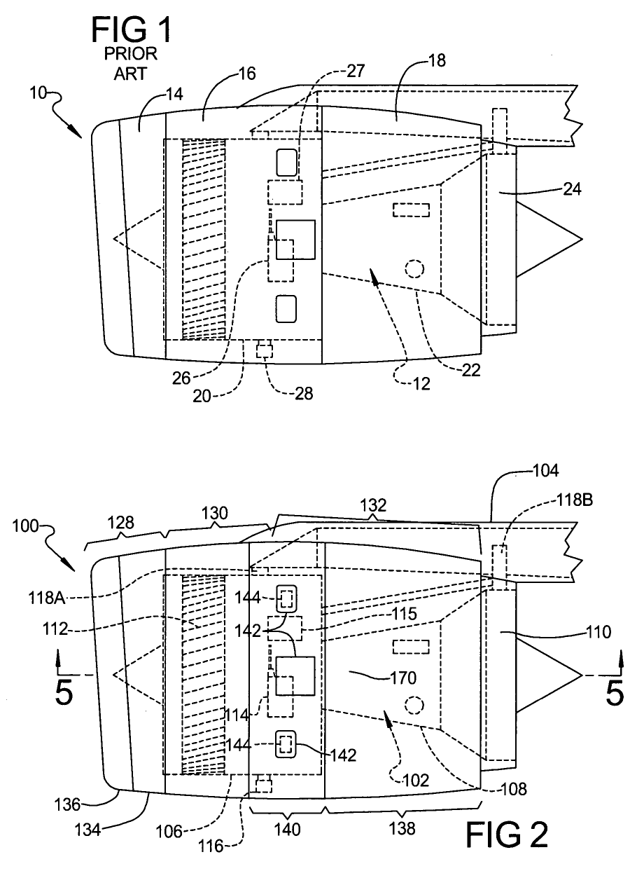

### DETAILED DESCRIPTION OF THE PREFERRED EMBODIMENTS

The following description of the preferred embodiments is merely exemplary in nature and is in no way intended to limit the invention, its application, or uses.

With initial reference to FIGS. 2 through 4, an aircraft engine nacelle 100 is shown. The nacelle 100 houses an aircraft engine 102. The nacelle 100 and the engine 102 are mounted to an aircraft (not shown) by a pylon or strut 104.

The engine 102 can be any conventional engine such as, for example, a high-bypass ratio aircraft engine. Typically, the engine 102 includes a fan case 106 and various components aft of the fan case 106, such as an engine core 108 including, for example, a nozzle 110. As described herein, “aft” is the right side of the engine 102 as viewed in the figures and “forward” is the left side. Further, the components aft of the fan case 106, such as the core 108, are downstream of the fan case 106 relative to a direction of airflow, which enters the engine 102 through the inlet 128 and flows through the remainder of the engine 102.

The fan case 106 houses the engine fan 112 and is cylindrical. Various components and devices of the engine 102 are mounted to the fan case 106, such as an oil tank 114, an engine control unit (ECU) 115, and often the gear box 116. The engine 102 is mounted to the pylon 104 by one or more mounts 118 of the pylon 104. The mounts 118 can secure the engine 102 at a variety of different locations. As illustrated, a mount 118A is located at the fan case 106 and a mount 118B is located at the engine core 108.

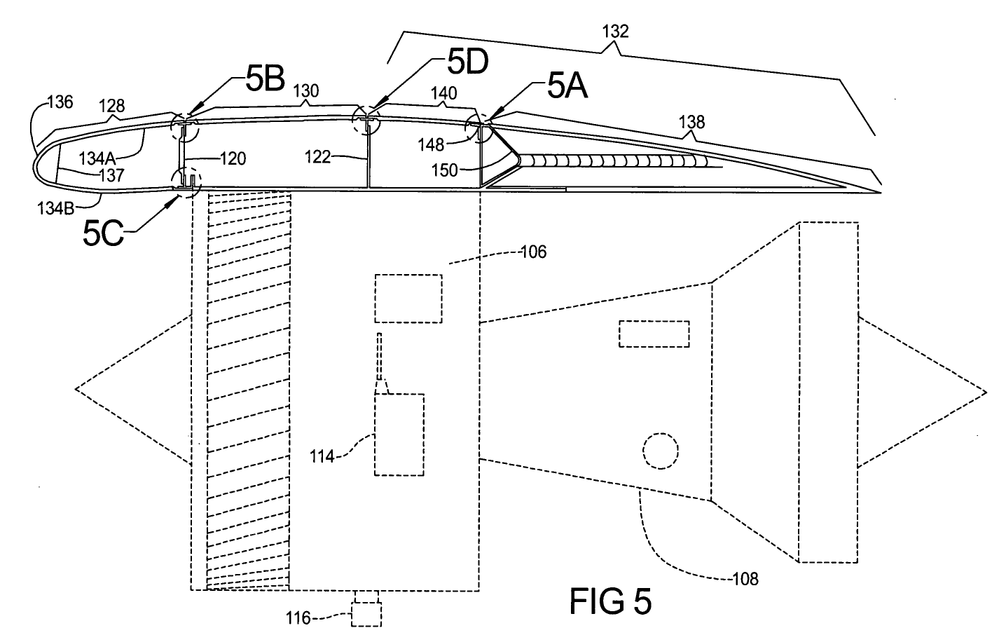

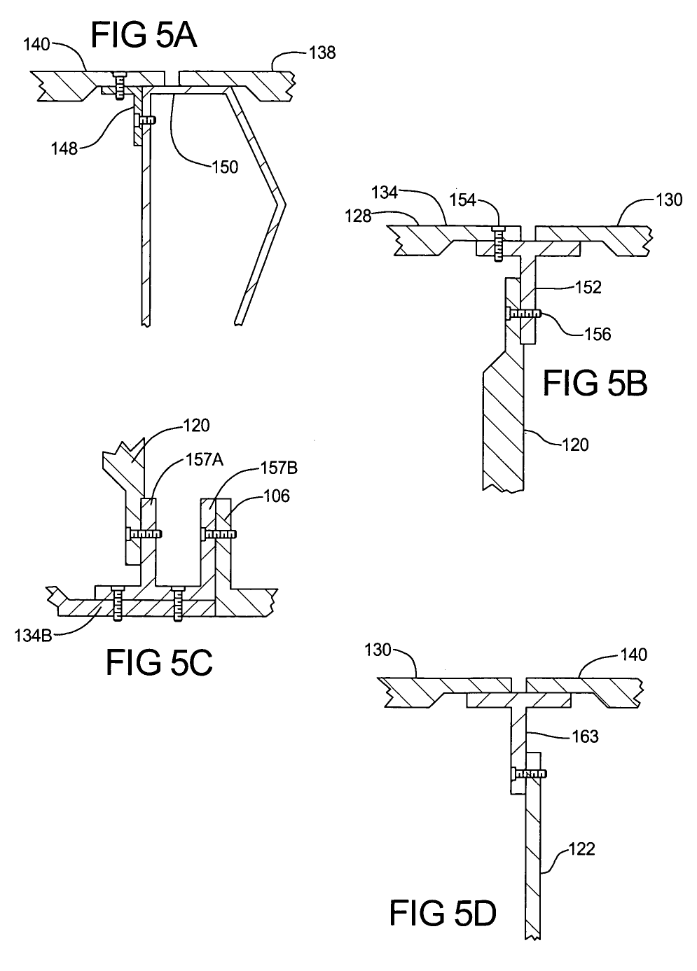

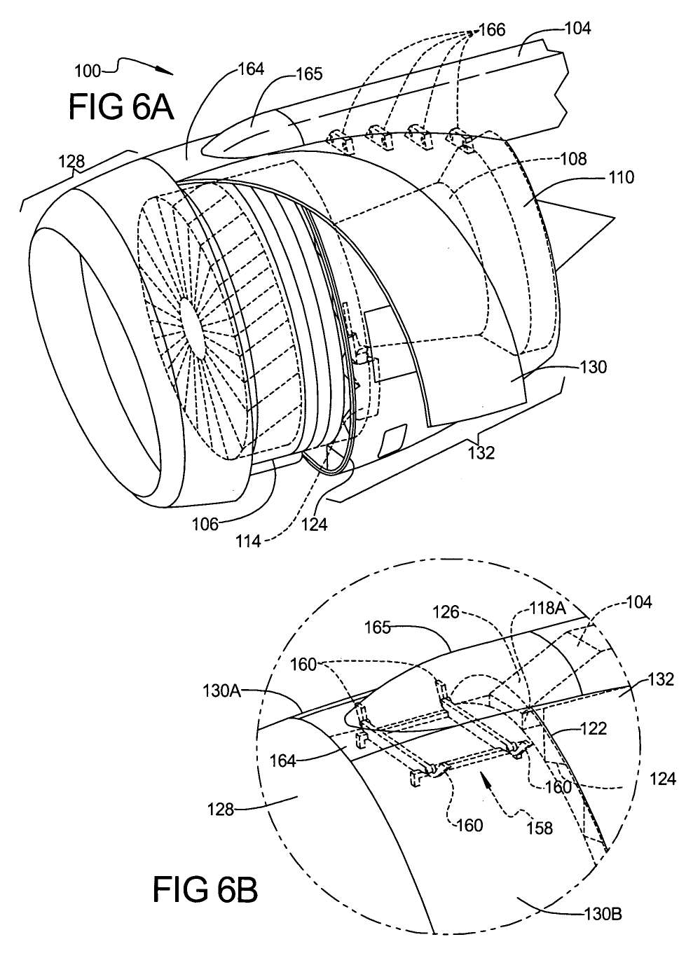

As illustrated in FIG. 5, also mounted at or near an exterior surface of the fan case 106 is an inlet aft bulkhead 120 and a support ring 122. Both the bulkhead 120 and the support ring 122 extend around the outer diameter of the fan case 106. The bulkhead 120 and the support ring 122 are mounted at or near the fan case 106. The support ring 122 is mounted by a series of trusses that are generally “V” shaped. FIG. 6 illustrates a truss 124 of the support ring 122. The bulkhead 120 and the support ring 122 can also be mounted at or near the fan case 106 in any other suitable manner. The bulkhead 120 is mounted generally at or near the forward portion of the fan case 106 and the support ring 122 is generally mounted at the aft portion of the fan case 106. As illustrated, the support ring 122 is mounted near the oil tank 114.

The nacelle 100 is generally cylindrical and includes an inlet cowl 128, a fan cowl 130, and a thrust reverser 132. The position of these components of the nacelle 100 is first set forth below and a description of how these components are mounted follows.

The inlet cowl 128 includes an inner barrel 134B, an outer barrel 134A, a nose lip 136, and a forward bulkhead 137. The outer and inner barrels 134 are aft of the nose lip 136 and the forward bulkhead 137. The inlet cowl 128 surrounds an area forward of the fan case 106, which is left of the fan case 106 as illustrated. The inlet cowl 128 receives airflow to the engine 102.

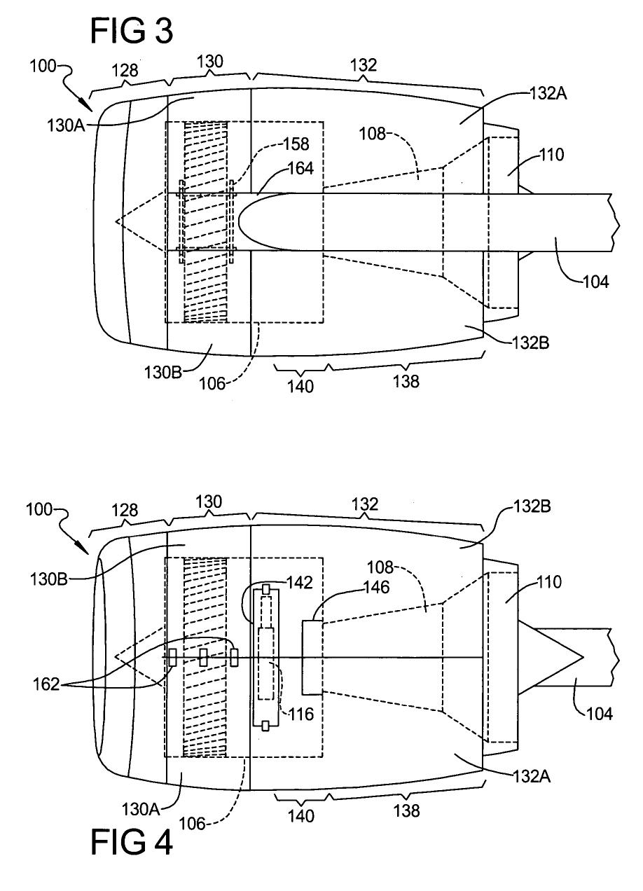

The fan cowl 130 surrounds and/or covers the fan case 106. The fan cowl 130 covers approximately the forward half of the fan case 106 and does not cover approximately the aft half of the fan case 106. With reference to FIGS. 3 and 4, the fan cowl 130 includes a first fan cowl panel 130A and a second fan cowl panel 130B.

The thrust reverser 132 also surrounds and/or covers a portion of the fan case 106. In particular, the thrust reverser 132 includes a main body 138 and an extended portion 140. The extended portion 140 has a longitudinal length sufficient to cover approximately the aft half of the fan case 106. The extended portion 140 includes one or more openings or doors 142 to permit access to the fan case 106 itself and various other components, such as the oil tank 114, the gear box 116, the ECU 115, and thrust reverser actuators 144. The main body 138 has a longitudinal length sufficient to cover the portions of the engine 102 aft of, or downstream of, the fan case 106, such as the engine core 108. The thrust reverser 132 includes a first thrust reverser portion 132A and a second thrust reverser portion 132B. The bottom of the main body 138 includes an opening or door 146 (FIG. 4) to provide access to the aft portion of the fan case 106.

The extended portion 140 can be integral with the main body 138 or the extended portion 140 can be a separate portion that is secured to the main body 138 in any suitable manner. For example and as illustrated in FIGS. 5 and 5A, the extended portion 140 can be secured to the main body 138 by a bracket 148 that generally takes the shape of an “L.” One end of the “L” bracket 148 is fixedly mounted to a torque box 150 of the main body 138. The other end of the “L” bracket is fixedly mounted to the extended portion 140. The torque box 150 is a support structure. The torque box 150 extends around the circumference of the forward portion of the main body 138 to provide support to the main body 138 and the extended portion 140.

The inlet cowl 128 is mounted to the inlet aft bulkhead 120 to support the inlet cowl 128 at the forward end of the fan case 106. Specifically, the nose lip 136 is fixedly mounted to the forward bulkhead 137 and/or the outer/inner barrel 134 in any suitable manner and the outer/inner barrel 134 is fixedly mounted to the inlet bulkhead 120. With reference to FIG. 5B, the outer barrel 134A is mounted to the bulkhead 120 by a bracket 152. The bracket 152 is generally “T” shaped. The outer barrel 134A is mounted to one end of the bracket 152 in any suitable manner, such as with a fastener 154. The opposite end of the bracket 152 is mounted to the bulkhead 120 with a fastener 156. The bracket 152 also abuts the fan cowl 130 and provides support to the fan cowl 130. With reference to FIG. 5C, the inner barrel 134B is mounted to the fan case 106 by a ring bearing 157. The bearing 157 extends around the inner barrel 134B and is secured to the inner barrel 134B in any suitable manner, such as by any conventional fastener. The bearing 157 includes knobs 157A and 157B. The knob 157A is mounted to the inlet bulkhead 120 using any conventional fastening system or device to secure the inner barrel 134B to the inlet bulkhead 120. The knob 157B is secured to the fan case 106 using any suitable fastening device or system to secure the inlet cowl 128 to the fan case 106.

With additional reference to FIG. 6, the fan cowl 130 is mounted about the fan case 106 by a hinge assembly 158. The hinge assembly 158 includes a plurality of hinges 160 on each side of the hinge assembly 158. The hinge assembly 158 can be fixedly secured to the fan case 106 in any suitable manner using any suitable fastening device or fastening means. In some embodiments, the hinge assembly 158 can be attached to the pylon 104. The first fan cowl panel 130A is mounted to the hinges 160 of one side of the hinge assembly 158 and the second fan cowl panel 130B is mounted to the hinges 160 of the opposite side of the hinge assembly 158 to allow the portions 130A and 130B to pivot about the hinges 160. The first and second portions 130A and 130B are secured together at the under surface of the nacelle 100 by a series of latches 162 (FIG. 4). With reference to FIG. 5B, the fan cowl 130 is supported about the engine 102 not only by the bracket 152, but also by a “T” shaped bracket 163 that is secured to the support ring 122 by fasteners.

As illustrated in FIGS. 6A and 6B, the hinge assembly 158 is covered by an upper fixed fairing 164. The upper fixed fairing 164 is secured over the hinge assembly 158 in any suitable manner, such as by being fastened to the pylon 104. The fairing 164 includes a raised portion 165 to accommodate the pylon 104.

The thrust reverser 132 is mounted about the aft portion of the fan case 106 and the engine core 108 by a series of hinges 166. The hinges 166 are fixedly mounted to the pylon 104 in any suitable manner. The thrust reverser 132 includes a first thrust reverser portion 132A and a second thrust reverser portion 132B. The first and second portions 132A and 132B are secured to opposite sides of the hinges 166 to allow the first and second portions 132A and 132B to pivot about the hinges 166. The first and second portions 132A and 132B include a latch beam or a series of latches near the undersurface of the thrust reverser 132 to secure the portions 132A and 132B together. The latch beam is on the interior of the thrust reverser 132 and is not shown. The extended portion 140 of the thrust reverser 132 is supported about the fan case 106 by the bracket 163 of the support ring 122 (FIG. 5C).

With reference to FIG. 6A, access to the forward portion of the fan case 106 is provided by opening the fan cowl 130 in a “clamshell” type manner. The majority of the components of the fan case 106 are located on, and can be accessed at, the aft portion of the fan case 106, which is covered by the extended portion 140 of the thrust reverser 132, making it seldom necessary to open the fan cowl 130. Therefore, the fan cowl 130 need not include equipment for automatically opening the fan cowl 130 and supporting the fan cowl 130 in the open position of FIG. 6A. However, in some applications the fan cowl 130 may include equipment, such as conventional hydraulic equipment and “hold open” rods, to open and support the fan cowl 130 in the open position.

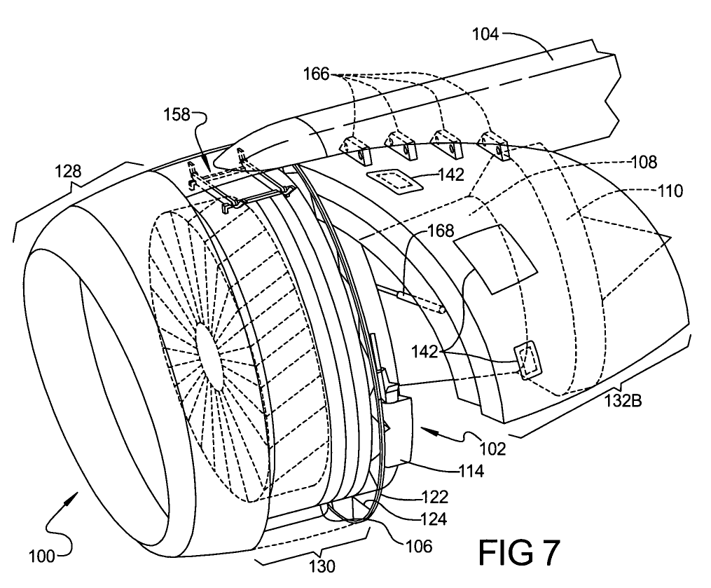

With reference to FIG. 7, access to the aft portion of the fan case 106 and the portions of the engine 102 aft of the fan case 106, such as the engine core 108, is provided by opening the thrust reverser 132 in a “clamshell” type manner such that the first portion 132A and the second portion 132B pivot about the hinges 166. The majority of the components of the fan case 106 are located on the aft portion of the fan case 106, or can be accessed at the aft portion of the fan case 106, and numerous important components of the engine 102, such as the engine core 108, are aft of the fan case 106. Therefore, it is often necessary to open the thrust reverser 132 to gain access to such components for servicing.

To facilitate opening of the thrust reverser 132 the thrust reverser 132 includes an opening mechanism. The opening mechanism may be any suitable thrust reverser opening and support mechanism as is commonly known in the art. The opening mechanism comprises one or more hydraulic actuators 168 and hold open rods (not shown). Both the first and the second thrust reverser portions 132A and 132B are opened and closed, and supported in the open position, by one of the actuators 168 (only one of which is illustrated). The actuators 168 are connected to a different one of the portions 132A and 132B at one end and a portion of the engine 102 or the pylon 104 at the opposite end. Use of the actuators 168 to open, hold open, and close the thrust reverser 132 is particularly helpful because the majority of the components of the engine 102 that require access for servicing are concealed by, or can be accessed beneath, the thrust reverser 132.

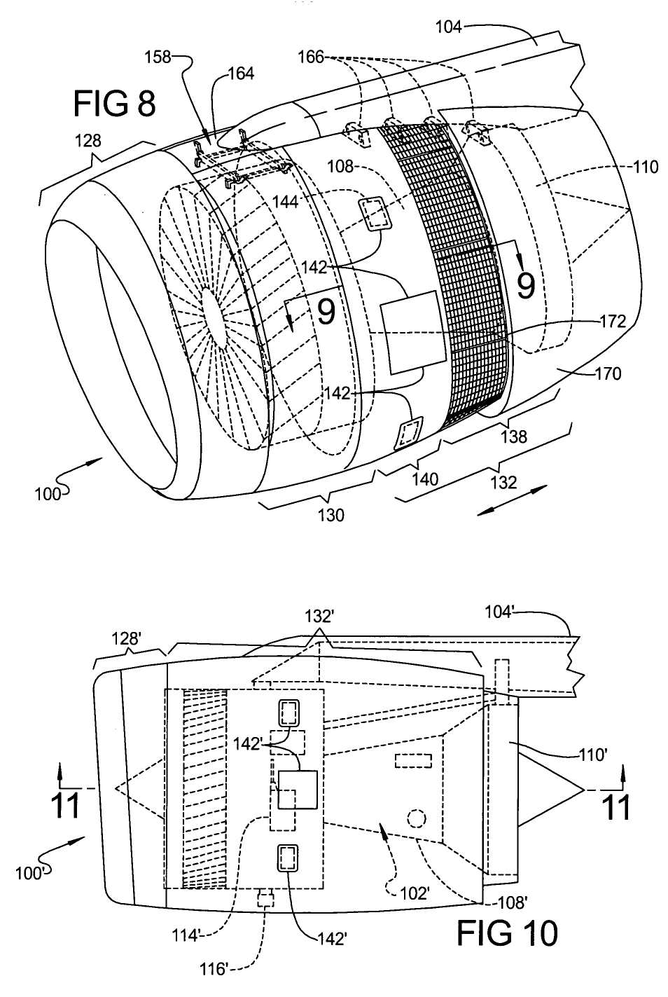

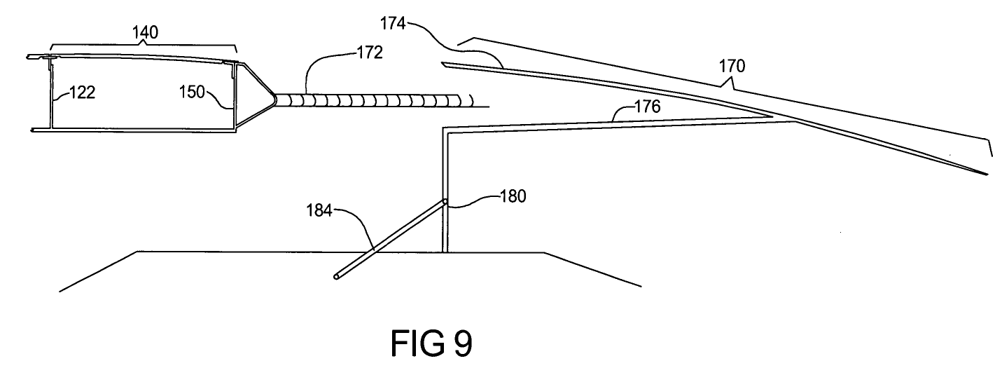

With additional reference to FIGS. 8 and 9, the thrust reverser 132 further includes a translating panel 170 and a grating 172 in the form of turning vanes for re-directing air flow. The panel 170 and the grating 172 are located at the forward portion of the main body 138 just aft of the extended portion 140. The panel 170 includes an outer panel 174 and an inner panel 176. The inner panel 176 is closer to the engine than the outer panel 174. The grating 172 is between the outer panel 174 and the inner panel 176. The panel 170 includes blocker doors 180 and support rods 182 that cooperate with guide tracks 184 to guide the panel 170 between a closed position (FIG. 2), in which the panel 170 abuts the torque box 150, and an open position (FIGS. 8 and 9). When the panel 170 is in the closed position the engine 102 operates to produce forward thrust to propel the aircraft forward. When the panel 170 is in the open position air flow of the engine is redirected through the grating 172 by the blocker door 180 to produce reverse thrust to slow the aircraft or propel the aircraft in reverse.

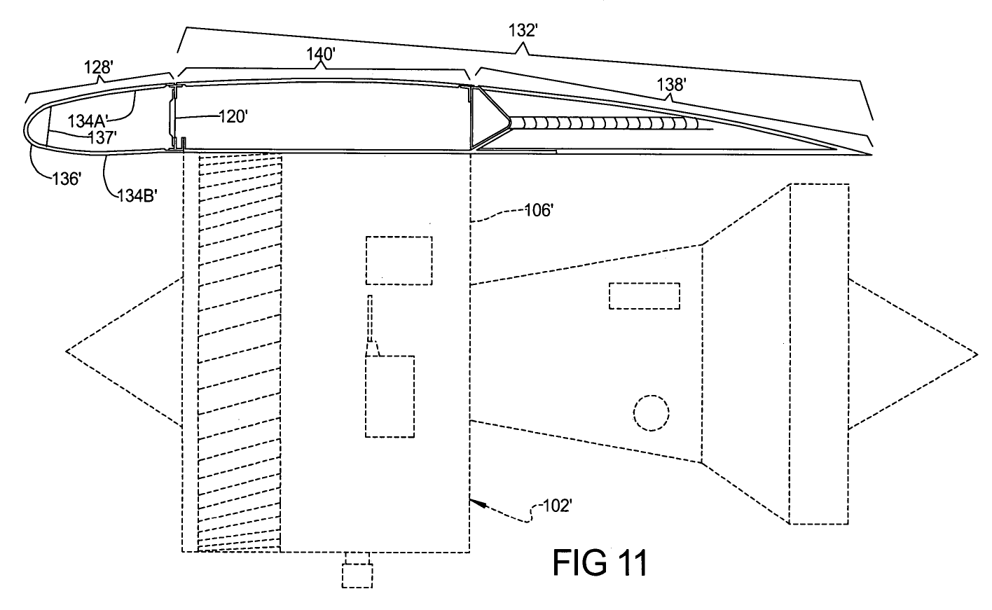

With additional reference to FIGS. 10 and 11, an aircraft engine nacelle according to an additional embodiment of the present invention is illustrated at 100′. Elements of the nacelle 100′ that are similar to elements of the nacelle 100 are designated with like reference numbers, but include the prime (′) designation. The description of the like elements provided in connection with the description of the nacelle 100 equally applies to the nacelle 100′.

The nacelle 100′ does not include the fan cowl 130 of the nacelle 100. Instead, the thrust reverser 132′ of the nacelle 100′ extends across substantially the entire fan case 106′ to take the place of the fan cowl 130. Specifically, the extended portion 140′ of the thrust reverser 132′ takes the place of the fan cowl 130 and extends to the inlet cowl 128 where the extended portion 140′ is supported by the inlet aft bulkhead 120. Eliminating the fan cowl 130 and replacing it with the extended portion 140′ decreases the weight of the nacelle 100′ because it eliminates the need for the support ring 122 and the need for a device to open and close the fan cowl 130, as well as support the fan cowl 130 in the open position. Elimination of the fan cowl 130 also can provide longer runs of laminar flow of air over the nacelle 100′, thus increasing fuel efficiency.

The present invention provides numerous advantages over the prior art. For example, the thrust reverser 132 of the present invention is extended to cover at least a portion of the fan case 106 to take to permit access to the fan case 106 and numerous components mounted to the fan case 106 without having to open the fan cowl 130, making it rarely necessary to open the fan cowl 130. In some embodiments the fan cowl 130 can be eliminated entirely. Because the fan cowl 130 rarely needs to be opened or can be eliminated entirely, the conventional mechanisms used to open and close the fan cowl 130 and support the fan cowl 130 in the open position can be eliminated. Elimination of such mechanisms reduces the weight of the nacelle 100 and the weight of the associated aircraft, thereby providing enhanced fuel economy. Also, elimination of the fan cowl 130 increases the laminar flow of air over the nacelle 100′ by eliminating the joint between the fan cowl 130 and the thrust reverser 132, thus increasing fuel efficiency.

While various preferred embodiments have been described, those skilled in the art will recognize modifications or variations which might be made without departing from the inventive concept. The examples illustrate the invention and are not intended to limit it. Therefore, the description and claims should be interpreted liberally with only such limitation as is necessary in view of the pertinent prior art.

What is claimed is:

1. A nacelle for housing an aircraft jet engine, wherein the jet engine has a fan case and a portion disposed downstream of the fan case relative to a direction of airflow through the jet engine, the nacelle comprising:
an inlet for receiving airflow;
a fan cowl panel for covering a forward portion of the fan case; and
a thrust reverser having a longitudinal length sufficient to cover the downstream portion of the jet engine in addition to a rearward portion of the fan case;
wherein opening the thrust reverser enables access to an entire area formed by the downstream portion as well as the rearward portion of the fan case.

2. The nacelle of claim 1, further comprising a stiffening ring between the fan cowl panel and the thrust reverser to support the fan cowl panel and the thrust reverser about the fan case.

3. The nacelle of claim 2, wherein the stiffening ring is mounted to the fan case by a series of trusses.

4. The nacelle of claim 1, wherein the thrust reverser includes a door to provide access to areas of the engine covered by the thrust reverser.

5. The nacelle of claim 1, wherein the thrust reverser includes a sub-panel that opens to produce reverse thrust.

6. The nacelle of claim 1, wherein opening the thrust reverser enables access to an oil tank mounted to the fan case.

7. The nacelle of claim 1, wherein opening the thrust reverser enables access to an engine control unit of the fan case.

8. A nacelle for housing an aircraft jet engine, wherein the jet engine has a fan case and a portion disposed downstream of the fan case relative to a direction of air flowing through the jet engine, the nacelle comprising:
an inlet for receiving airflow;
a fan cowl panel for covering about a forward half of the fan case; and
a thrust reverser including:
a main body having a longitudinal length sufficient to cover the downstream portion of the jet engine; and
an extended portion mounted to the main body having a longitudinal length sufficient to cover approximately an aft half of the fan case;
wherein opening the thrust reverser enables access to an entire area formed by the downstream portion as well as approximately the aft half of the fan case.

9. The nacelle of claim 8, wherein the extended portion is mounted to a torque box of the main body.

10. The nacelle of claim 8, further comprising a stiffening ring between the fan cowl panel and the thrust reverser to support the fan cowl panel and the extended portion of the thrust reverser about the fan case.

11. The nacelle of claim 10, wherein the stiffening ring is mounted to the fan case by a series of trusses.

12. The nacelle of claim 8, wherein the thrust reverser includes a door to provide access to areas of the engine covered by the thrust reverser.

13. The nacelle of claim 8, wherein opening the thrust reverser enables access to at least one of an oil tank, a gear box, and an engine control unit mounted to the fan case.

14. A nacelle for housing an aircraft jet engine, wherein the jet engine has a fan case and a portion disposed downstream of the fan case relative to a direction of air flowing through the jet engine, the nacelle comprising:
an inlet for receiving airflow; and
a thrust reverser having a longitudinal length sufficient to cover the downstream portion of the jet engine and the entire fan case;
wherein opening the thrust reverser enables access to an entire area formed by the downstream portion as well as the entire fan case.

15. The nacelle of claim 14, wherein the thrust reverser includes doors to provide access to areas of the engine covered by the thrust reverser.

16. The nacelle of claim 14, wherein the thrust reverser further comprises:
a main body having a longitudinal length sufficient to cover the downstream portion of the jet engine; and
an extended portion mounted to the main body having a longitudinal length sufficient to cover the entire fan case.

17. The nacelle of claim 16, wherein the extended portion is mounted to a torque box of the main body.

18. The nacelle of claim 14, wherein the extended portion abuts the inlet.
